(19) United States
(12) Patent Application Publication
(10) Pub. No.: US 2015/0330715 A1
(43) Pub. Date: Nov. 19, 2015

(54) MANUFACTURING METHOD OF THERMAL MODULE

(71) Applicant: ASIA VITAL COMPONENTS CO., LTD., New Taipei City (TW)

(72) Inventor: Ming-Han Yu, New Taipei City (TW)

(73) Assignee: ASIA VITAL COMPONENTS CO., LTD., New Taipei City (TW)

(21) Appl. No.: 14/277,058

(22) Filed: May 14, 2014

(51) Int. Cl. F28D 15/02; F28D 15/04; B23P 15/26

(52) U.S. Cl. CPC F28D 15/0275; B23P 15/26; F28D 15/04

(57) ABSTRACT

A manufacturing method of thermal module includes steps of: providing a base seat and a heat pipe, the base seat having a first face and a second face; mechanically processing the base seat from the first face to the second face to form a receiving channel having a bottom section and a first side section and a second side section respectively vertically extending from two sides of the bottom section; placing the heat pipe into the receiving channel; mechanically processing the base seat and the heat pipe to hold the base seat and the heat pipe in a direction normal thereto; and horizontally mechanically processing the base seat and the heat pipe from outer sides to inner sides of the first and second side sections to form a recess on each of the first and second side sections, whereby a protrusion section is formed to press the heat pipe.

### BACKGROUND OF THE INVENTION

1. Field of the Invention

The present invention relates generally to a manufacturing method of thermal module, and more particularly to a manufacturing method of thermal module, which increases the heat conduction efficiency, enhances the assembling strength and lowers the manufacturing cost.

2. Description of the Related Art

Along with the development of electronic product technologies, the volumes of various chips (such as central processors) have been gradually minified. In order to process more data, the same volume of chip can contain several times more components than the conventional chip. The more the number of the components in the chip is, the higher the heat generated by the working components is. With a usually seen central processor taken as an example, the heat generated by the working central processor is high enough to burn down the entire central processor. Therefore, it has become an important topic in this field how to develop high-performance heat dissipation devices for various chips.

The current heat dissipation device or thermal module is composed of multiple identical and different heat dissipation components in cooperation with each other. The heat dissipation components can be heat pipes, heat sinks, heat dissipation base seats, etc. These heat dissipation components are securely assembled with each other mainly by means of welding. With respect to aluminum-made heat dissipation components, it is necessary to previously perform several welding aiding steps and then weld the components by means of a special welding process. Therefore, the welding method of such components is complicated and the processing cost is high.

Some manufacturers use fastening members such as screws to securely connect the heat dissipation components. However, the fastening members can be only applied to some of the heat dissipation components (such as the radiating fin assembly and the heat dissipation base seat). It is impossible to directly fix the heat pipe by means of screwing.

Furthermore, in the conventional method, the heat dissipation base seat is formed with a perforation or a channel in which the heat pipe is inlaid and connected with the heat dissipation base seat. This can overcome the problem that the heat pipe cannot be fixed by means of welding or screwing. However, the heat is indirectly transferred to the heat pipe through the heat dissipation base seat. The gap between the heat pipe and the heat dissipation base seat is likely to cause thermal resistance. As a result, the heat conduction efficiency is lowered.

According to the above, the conventional method has the following shortcomings:

1. The manufacturing cost is higher.

2. The heat conduction efficiency is lowered.

### SUMMARY OF THE INVENTION

It is therefore a primary object of the present invention to provide a manufacturing method of thermal module, which can greatly increase the heat conduction efficiency.

It is a further object of the present invention to provide the above manufacturing method of thermal module, which can enhance the assembling strength.

It is still a further object of the present invention to provide the above manufacturing method of thermal module, which can lower the manufacturing cost.

It is still a further object of the present invention to provide a thermal module, which has higher heat conduction efficiency.

It is still a further object of the present invention to provide the above thermal module, which has higher assembling strength.

It is still a further object of the present invention to provide the above thermal module, which is manufactured at lower cost.

To achieve the above and other objects, the manufacturing method of thermal module of the present invention includes steps of:
providing a base seat and a heat pipe, two faces of the base seat being defined as a first face and a second face;
mechanically processing the base seat from the first face to the second face to form a receiving channel, the receiving channel having a bottom section and a first side section and a second side section respectively vertically extending from two sides of the bottom section;
placing the heat pipe into the receiving channel of the base seat;
mechanically processing the base seat and the heat pipe to hold the base seat and the heat pipe in a direction normal to the base seat and the heat pipe; and
horizontally mechanically processing the base seat and the heat pipe from outer sides of the first and second side sections to inner sides of the first and second side sections to form a recess on each of the first and second side sections, whereby a protrusion section is formed to press the heat pipe.

According to the manufacturing method of the thermal module, after the base seat and the heat pipe are vertically held, a pressure is horizontally applied to the base seat and the heat pipe from outer sides of the first and second side sections of the receiving channel to inner sides of the first and second side sections to form a recess on each of the first and second side sections, whereby a protrusion section is correspondingly formed at the junction between the first and second side sections and the first face to press and secure the heat pipe. Accordingly, the heat can be directly conducted from the base seat to the heat pipe. In this case, the problem of the conventional method that the gap between the base seat and the heat pipe will lead to thermal resistance is overcome. Therefore, the heat conduction efficiency is greatly enhanced. In addition, the manufacturing method of the thermal module can be easily performed so that the manufacturing cost is greatly lowered.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a view showing a first embodiment of the manufacturing method of thermal module of the present invention;

FIG. 2A is a perspective assembled view of the first embodiment of the manufacturing method of thermal module of the present invention;

FIG. 2B is an enlarged view of circled area of FIG. 2A;

FIG. 3A is another perspective assembled view of the first embodiment of the manufacturing method of thermal module of the present invention;

FIG. 3B is an enlarged view of circled area of FIG. 3A;

FIG. 4 is a flow chart of the first embodiment of the manufacturing method of thermal module of the present invention;

FIG. 5A is a perspective assembled view of a second embodiment of the manufacturing method of thermal module of the present invention;

FIG. 5B is another perspective assembled view of the second embodiment of the manufacturing method of thermal module of the present invention;

FIG. 6A is a perspective exploded view of a first embodiment of the thermal module of the present invention; and

FIG. 6B is a perspective assembled view of the first embodiment of the thermal module of the present invention.

### DETAILED DESCRIPTION OF THE PREFERRED EMBODIMENTS

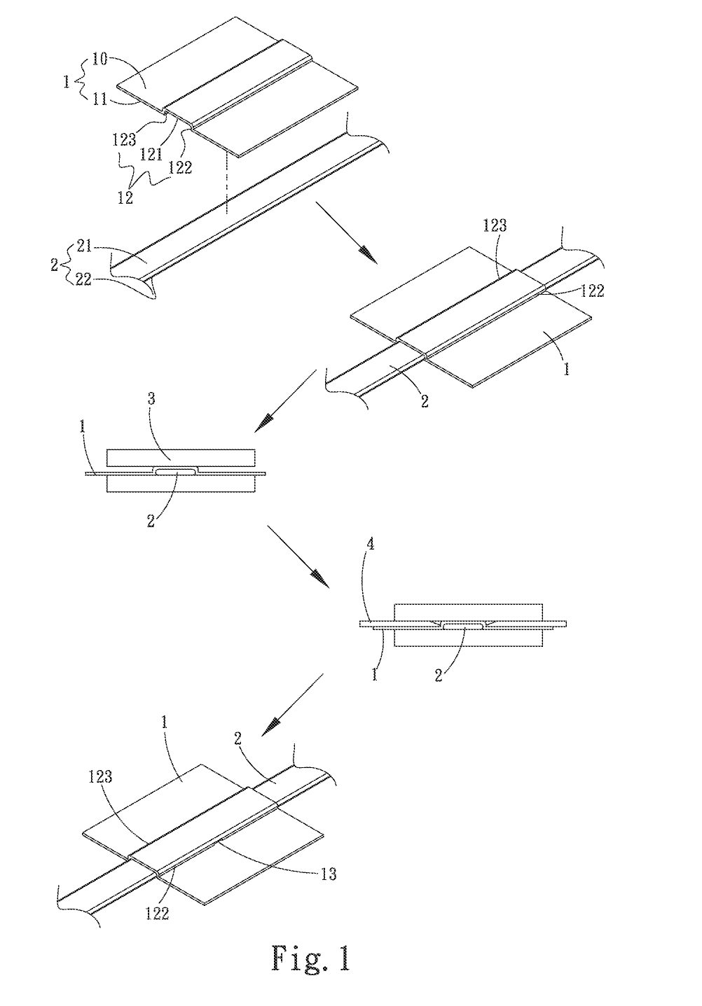

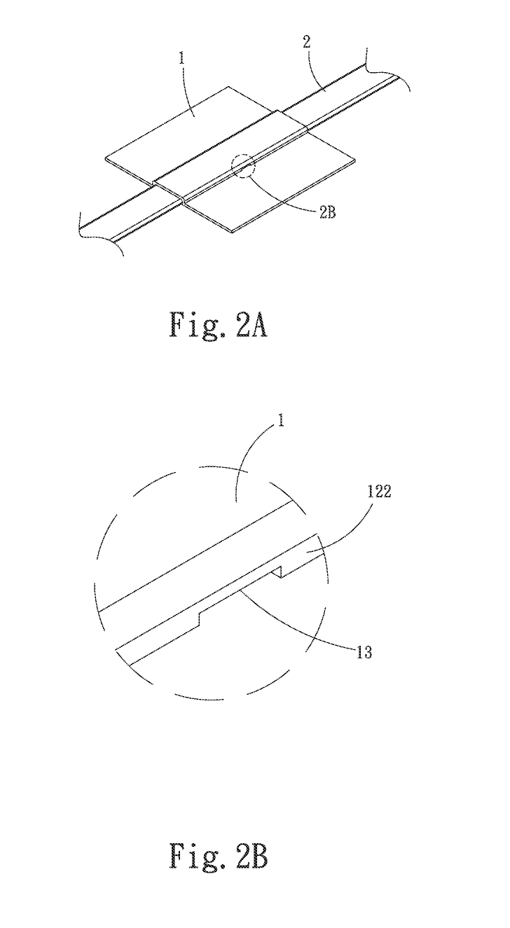

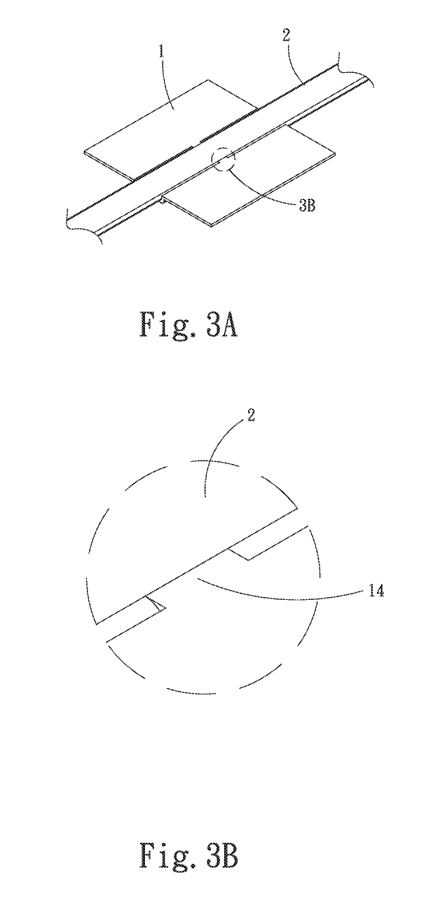

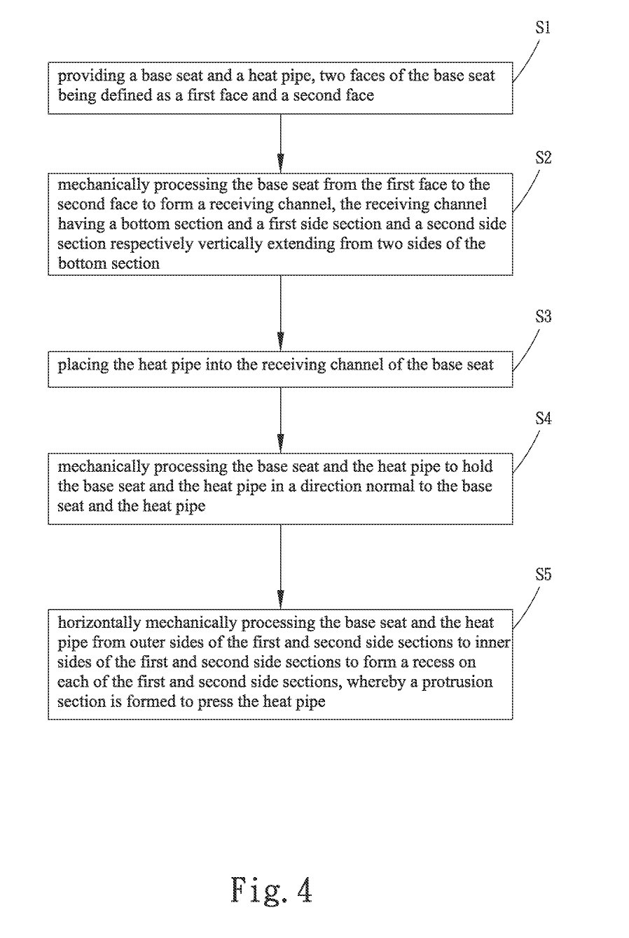

Please refer to FIGS. 1, 2A, 2B, 3A, 3B and 4. FIG. 1 is a view showing a first embodiment of the manufacturing method of thermal module of the present invention. FIG. 2A is a perspective assembled view of the first embodiment of the manufacturing method of thermal module of the present invention. FIG. 2B is an enlarged view of circled area of FIG. 2A. FIG. 3A is another perspective assembled view of the first embodiment of the manufacturing method of thermal module of the present invention. FIG. 3B is an enlarged view of circled area of FIG. 3A. FIG. 4 is a flow chart of the first embodiment of the manufacturing method of thermal module of the present invention. According to the first embodiment, the manufacturing method of thermal module of the present invention includes steps of:

S1. providing a base seat and a heat pipe, two faces of the base seat being defined as a first face and a second face, a base seat 1 and a heat pipe 2 being provided, two faces of the base seat 1 being defined as a first face 10 and a second face 11, the heat pipe 2 being a flat-plate heat pipe having an upper face 21 and a lower face 22;

S2. mechanically processing the base seat from the first face to the second face to form a receiving channel, the receiving channel having a bottom section and a first side section and a second side section respectively vertically extending from two sides of the bottom section, a pressure being applied to the base seat to mechanically process the base seat 1 from the first face 10 to the second face 11 to form a receiving channel 12, the receiving channel 12 having a bottom section 121 and a first side section 122 and a second side section 123 respectively vertically extending from two sides of the bottom section 121;

S3. placing the heat pipe into the receiving channel of the base seat, the heat pipe 2 being placed into the receiving channel 12 of the base seat 1;

S4. mechanically processing the base seat and the heat pipe to hold the base seat and the heat pipe in a direction normal to the base seat and the heat pipe, a first mold set 3 being used to apply a pressure to the base seat 1 and the heat pipe 2 to mechanically process the base seat 1 and the heat pipe 2 and hold the base seat 1 and the heat pipe 2 in a direction normal to the base seat 1 and the heat pipe 2, whereby the base seat 1 and the heat pipe 2 are prevented from moving; and

S5. horizontally mechanically processing the base seat and the heat pipe from outer sides of the first and second side sections to inner sides of the first and second side sections to form a recess on each of the first and second side sections, whereby a protrusion section is formed to press the heat pipe, a second mold set 4 being used to horizontally apply a pressure to the base seat 1 and the heat pipe 2 from outer sides of the first and second side sections 122, 123 to inner sides of the first and second side sections 122, 123 to form a recess 13 on each of the first and second side sections 122, 123, whereby a protrusion section 14 is formed at the junction between the first and second side sections 122, 123 and the first face 10 to press the heat pipe 2, the lower face 22 of the heat pipe 2 being flush with the second face 11 of the base seat 1.

In this embodiment, the mechanical processing is, but not limited to, press processing for illustration purposes only.

In the manufacturing method of the thermal module, after the base seat 1 and the heat pipe 2 are vertically held, the base seat 1 and the heat pipe 2 cannot be moved. Then a pressure is horizontally applied to the base seat 1 and the heat pipe 2 from outer sides of the first and second side sections 122, 123 of the receiving channel 12 to inner sides of the first and second side sections 122, 123 to form a recess 13 on each of the first and second side sections 122, 123, whereby a protrusion section 14 is correspondingly formed at the junction between the first and second side sections 122, 123 and the first face 10 to press and secure the heat pipe 2. Accordingly, the heat can be directly conducted from the base seat 1 to the heat pipe 2. In this case, the problem of the conventional method that the gap between the base seat and the heat pipe will lead to thermal resistance is overcome. Therefore, the heat conduction efficiency is greatly enhanced and the assembling strength is increased. In addition, the manufacturing method of the thermal module can be easily performed without using any fastening member such as screw for connecting the base seat and the heat pipe. Therefore, the cost for the fastening member is saved and the manufacturing cost is greatly lowered.

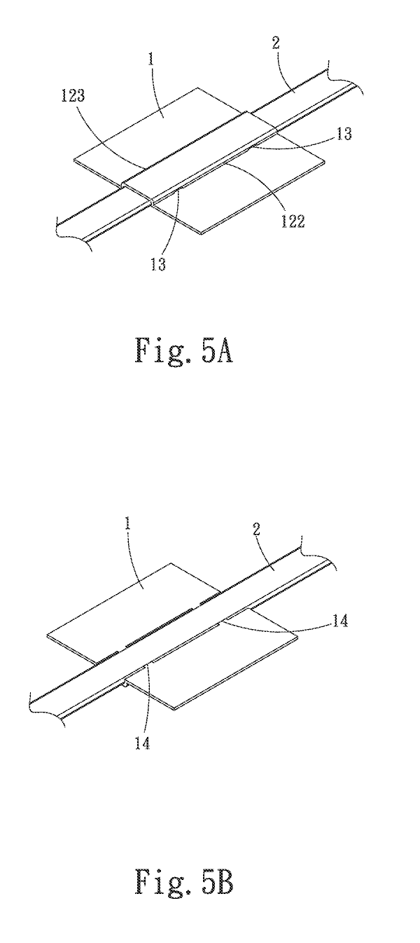

Please now refer to FIGS. 5A and 5B. FIG. 5A is a perspective assembled view of a second embodiment of the manufacturing method of thermal module of the present invention. FIG. 5B is another perspective assembled view of the second embodiment of the manufacturing method of thermal module of the present invention. The second embodiment is partially identical to the first embodiment in component and relationship between the components and thus will not be repeatedly described hereinafter. The second embodiment is different from the first embodiment in that the number of the recesses 13 horizontally formed on the first and second side sections 122, 123 from outer sides of the first and second side sections 122, 123 to inner sides of the first and second side sections 122, 123 is adjustable according to a user's requirement. The more the number of the recesses 13 is, the more the number of the protrusion sections 14 is. In this case, the heat pipe 2 can be more securely pressed by the protrusion sections 14 so that the heat pipe 2 can be more securely connected with the base seat 1.

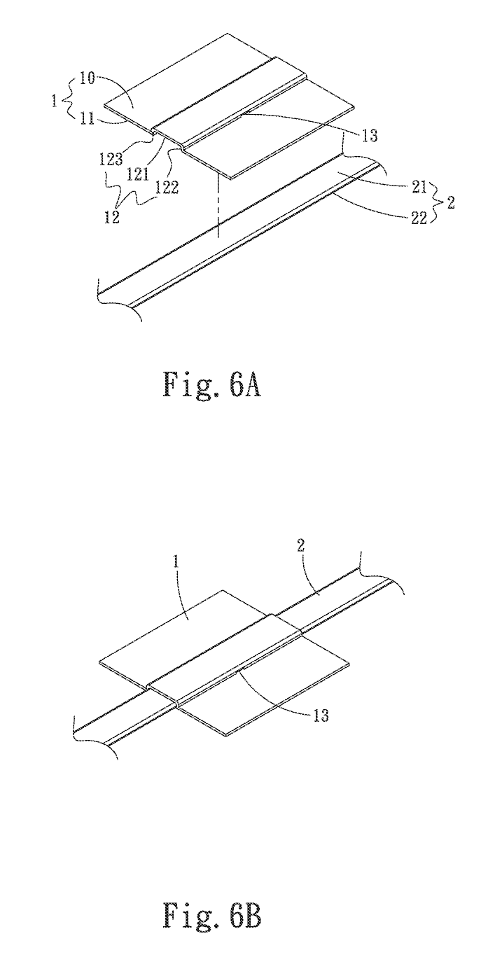

Please now refer to FIGS. 6A and 6B. FIG. 6A is a perspective exploded view of a first embodiment of the thermal module of the present invention. FIG. 6B is a perspective assembled view of the first embodiment of the thermal module of the present invention. According to the first embodiment, the thermal module of the present invention includes a base seat 1 and a heat pipe 2. The base seat 1 has a first face 10 and a second face 11. A middle section of the base seat 1 is formed with a receiving channel 12. The receiving channel 12 has a bottom section 121 and a first side section 122 and a second side section 123 respectively vertically extending from two sides of the bottom section 121. Each of the first and second side sections 122, 123 is formed with a recess 13 and a protrusion section 14 correspondingly formed in adjacency to the recess 13.

The heat pipe 2 is received in the receiving channel 12. The heat pipe 2 has an upper face 21 and a lower face 22. The protrusion sections 14 press the lower face 22 of the heat pipe 2.

According to the above arrangement, the protrusion sections 14 can securely press the heat pipe 2, whereby the heat can be directly conducted from the base seat 1 to the heat pipe 2. In this case, the problem of the conventional method that the gap between the base seat and the heat pipe will lead to thermal resistance is overcome. Therefore, the heat conduction efficiency is greatly enhanced and the assembling strength is increased.

According to the above, in comparison with the conventional method, the present invention has the following advantages:

1. The heat conduction efficiency is higher.

2. The assembling strength is increased.

3. The manufacturing cost is lowered.

The present invention has been described with the above embodiments thereof and it is understood that many changes and modifications in the above embodiments can be carried out without departing from the scope and the spirit of the invention that is intended to be limited only by the appended claims.

What is claimed is:

1. A manufacturing method of thermal module, comprising steps of:
providing a base seat and a heat pipe, two faces of the base seat being defined as a first face and a second face;
mechanically processing the base seat from the first face to the second face to form a receiving channel, the receiving channel having a bottom section and a first side section and a second side section respectively vertically extending from two sides of the bottom section;
placing the heat pipe into the receiving channel of the base seat;
mechanically processing the base seat and the heat pipe to hold the base seat and the heat pipe in a direction normal to the base seat and the heat pipe; and
horizontally mechanically processing the base seat and the heat pipe from outer sides of the first and second side sections to inner sides of the first and second side sections to form a recess on each of the first and second side sections, whereby a protrusion section is formed to press the heat pipe.

2. The manufacturing method of thermal module as claimed in claim 1, wherein the mechanical processing is press processing.

3. The manufacturing method of thermal module as claimed in claim 1, wherein the heat pipe is a flat-plate heat pipe having an upper face and a lower face, the lower face being flush with the second face of the base seat.

4. The manufacturing method of thermal module as claimed in claim 3, wherein the protrusion section is formed at a junction between the first and second side sections and the first face to press the lower face of the heat pipe.

5. A thermal module manufactured by the manufacturing method as claimed in claim 1, comprising:
a base seat having a first face and a second face, a middle section of the base seat being formed with a receiving channel, the receiving channel having a bottom section and a first side section and a second side section respectively vertically extending from two sides of the bottom section, each of the first and second side sections being formed with a recess and a protrusion section correspondingly formed in adjacency to the recess; and
a heat pipe received in the receiving channel, the heat pipe having an upper face and a lower face, the protrusion sections pressing the lower face of the heat pipe.
